(19) United States
(12) Patent Application Publication
(10) Pub. No.: US 2021/0245502 A1
(43) Pub. Date: Aug. 12, 2021

(54) LIQUID DISCHARGE APPARATUS

(71) Applicant: Brother Kogyo Kabushiki Kaisha, Nagoya-shi (JP)

(72) Inventor: Shotaro Kanzaki, Handa-shi (JP)

(73) Assignee: Brother Kogyo Kabushiki Kaisha, Nagoya-shi (JP)

(21) Appl. No.: 17/157,120

(22) Filed: Jan. 25, 2021

(30) Foreign Application Priority Data
Feb. 12, 2020 (JP) 2020-021756

(51) Int. Cl. B41J 2/045

(52) U.S. Cl. CPC B41J 2/04588; B41J 2/0458; B41J 2/04581

(57) ABSTRACT

There is provided a liquid discharge apparatus including: a channel unit having a nozzle surface in which a nozzle is opened; an actuator configured to apply an energy for discharging a liquid from the nozzle; and a controller. Ohnesorge number Oh is in a range from 0.17 to 0.34. The controller is configured to drive the actuator so that a velocity v of the liquid discharged from the nozzle is not more than 8 m/s.

### CROSS REFERENCE TO RELATED APPLICATION

The present application claims priority from Japanese Patent Application No. 2020-021756, filed on Feb. 12, 2020, the disclosure of which is incorporated herein by reference in its entirety.

### BACKGROUND

### Field of the Invention

The present disclosure relates to a liquid discharge apparatus which discharges or ejects a liquid from a nozzle by driving an actuator.

### Description of the Related Art

There is known that, in an ink-jet recording apparatus, the Ohnesorge number is made to be in a predetermined range (from not less than 0.10 to not more than 0.25) in order to form a stable image without any deviation in the position of landing dot(s).

### SUMMARY

However, even if the Ohnesorge number is made to be within the predetermined range, a satellite and/or mist are/is generated depending on the velocity of the liquid discharged or ejected from the nozzle. In such a case, any stable image cannot be formed.

An object of the present disclosure is to provide a liquid discharge apparatus capable of suppressing generation of the satellite and/or the mist.

According to an aspect of the present disclosure, there is provided a liquid discharge apparatus including: a channel unit having a nozzle surface in which a nozzle is opened; an actuator configured to apply an energy for discharging a liquid from the nozzle; and a controller. Ohnesorge number Oh is defined by:

Oh=μ/\sqrt{ρΓD}

μ: viscosity (mPa·s) of the liquid; ρ: density (g/m³) of the liquid; σ: surface tension (mN/m) of the liquid; and D: diameter (μm) of the nozzle. The Ohnesorge number is in a range from 0.17 to 0.34. The controller is configured to drive the actuator so that a velocity v of the liquid discharged from the nozzle is not more than 8 m/s.

According to the present disclosure, by making each of the Ohnesorge number and the velocity to be within the predetermined range, it is possible to suppress the generation of the satellite and/or the mist.

### BRIEF DESCRIPTION OF THE DRAWINGS

FIG. 1 is a plane view of a printer 100.

FIG. 2 is a block diagram depicting the electrical configuration of the printer 100.

FIG. 3 is a cross-sectional view of a head 1 included in the printer 100.

FIGS. 4A, 4B, 4C and 4D are wave-form charts each depicting a driving signal supplied by a driver IC 14 of the head 1 to an actuator 13x.

FIG. 5 is a graph depicting the Ohnesorge number and the Reynolds' Number.

### DESCRIPTION OF THE EMBODIMENTS

First, the overall configuration of a printer 100 according to an embodiment of the present disclosure will be explained.

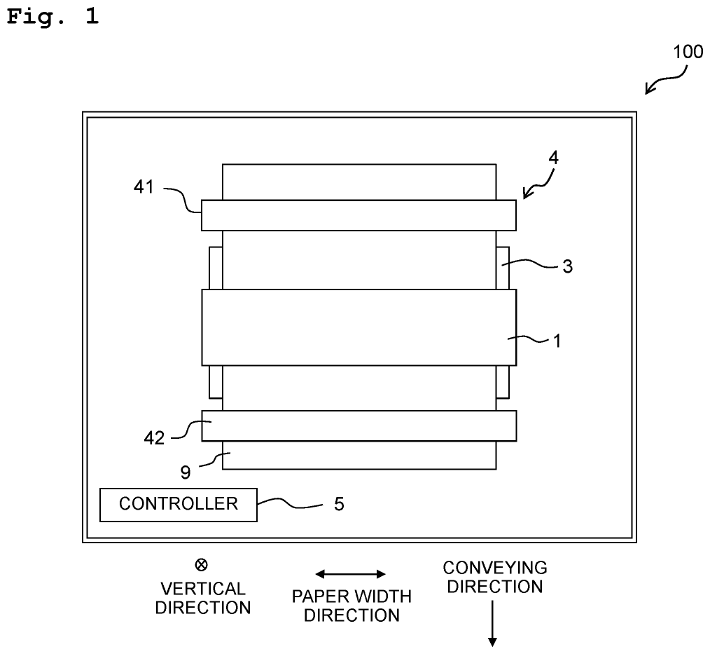

As depicted in FIG. 1, the printer 100 includes a head 1, a platen 3, a conveyor 4, and a controller 5.

The head 1 is long in a paper width direction (a direction orthogonal to the vertical direction) and is a head of the line system which ejects or discharges an ink to (toward) a paper sheet 9 in a state that the position of the head 1 is fixed.

The platen 3 is a plate-shaped member arranged at a location below the head 1. A paper sheet P is supported on the upper surface of the platen 3.

The conveyor 4 includes two roller pairs 41 and 42 which sandwich the head 1 and the platen 3 in a conveying direction (a direction orthogonal to the paper width direction and the vertical direction), and a conveying motor 43 (see FIG. 2) which rotates the two roller pairs 41 and 42. In a case that the conveying motor 43 is driven by the control of the controller 5, the two roller pairs 41 and 42 rotate in a state that the roller pairs 41 and 42 hold the paper sheet 9 therebetween, and the paper sheet 9 is conveyed in the conveying direction.

As depicted in FIG. 2, the controller 5 includes a Central Processing Unit 51 (CPU 51), a Read Only Memory 52 (ROM 52), and a Random Access Memory 53 (RAM 53). The ROM 52 stores a program and data with which the CPU 51 performs a variety of kinds of controls. The RAM 53 temporarily stores data which is used by the CPU 51 in a case that the CPU 51 executes the program. The CPU 51 executes the variety of kinds of controls in accordance with the program and data stored in the ROM 52 and RAM 53, based on data inputted from an external apparatus (a personal computer, etc.) and/or an inputting part (a switch and/or a button provided on an outer surface of a casing of the printer 100).

Next, the configuration of the head 1 will be explained specifically.

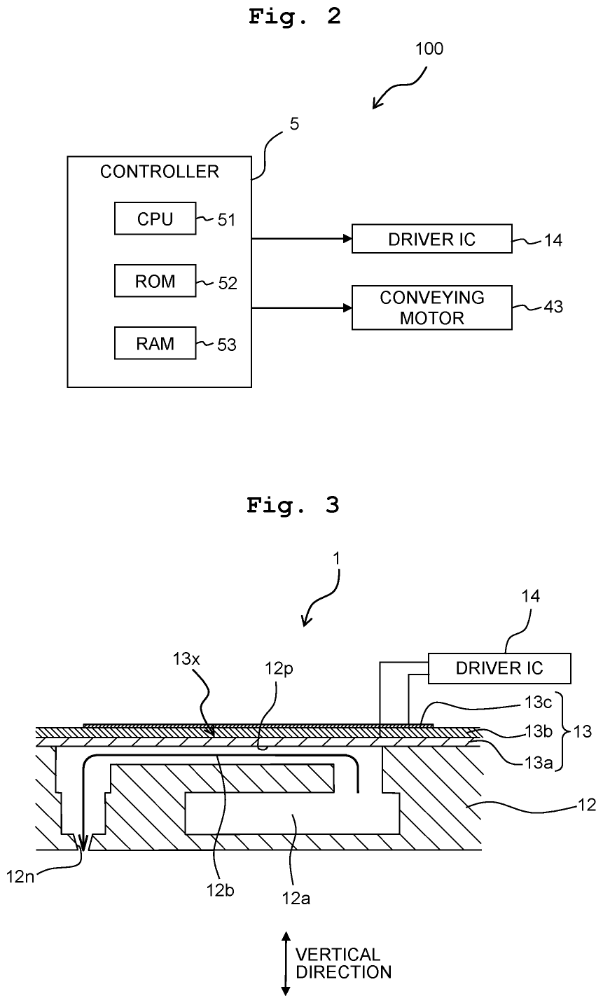

As depicted in FIG. 3, the head 1 includes a channel unit 12 and an actuator unit 13.

A common channel 12a and a plurality of individual channels 12b are formed in the channel unit 12. The common channel 12a communicates with an ink tank (not depicted in the drawings) and communicates with the plurality of individual channels 12b. Each of the plurality of individual channels 12b includes a nozzle 12n and a pressure chamber 12p communicating with the nozzle 12n. The ink flows from the common channel 12a into each of the plurality of individual channels 12b; in each of the plurality of individual channels 12b, the ink flows from the pressure chamber 12p to the nozzle 12n, and is ejected or discharged from the nozzle 12n. A plurality of pieces of the nozzle 12n are opened in a lower surface of the channel unit 12, and a plurality of pieces of the pressure chamber 12p are opened in an upper surface of the channel unit 12. In a plane orthogonal to the vertical direction, each of the plurality of nozzles 12n has a substantially circular shape and each of the plurality of pressure chambers 12p has a substantially rectangular shape.

The actuator unit 13 includes a metallic vibration plate 13a arranged on the upper surface of the channel unit 12 so as to cover the plurality of pressure chambers 12p, a piezoelectric layer 13b arranged on an upper surface the vibration plate 13a, and a plurality of individual electrodes 13c arranged in the upper surface of the piezoelectric layer 13b so as to face the plurality of pressure chambers 12p, respectively.

The vibration plate 13a and the plurality of individual electrodes 13c are electrically connected to a driver IC 14. The driver IC 14 maintains the potential of the vibration plate 13a at the ground potential. Further, the driver IC 14 changes the potential of each of the plurality of individual electrodes 13c. Specifically, the driver IC 14 generates a driving signal based on a control signal from the controller 5, and supplies the generated driving signal to each of the plurality of individual electrodes 13c. This causes the potential of each of the plurality of individual electrodes 13c to change between a predetermined driving potential and the ground potential. At this time, parts (actuator 13x), of the vibration plate 13a and the piezoelectric layer 13, respectively, which are sandwiched between each of the plurality of individual electrodes 13c and one of the plurality of pressure chambers 12p are deformed. This changes the volume of each of the plurality of pressure chambers 12p, and a pressure (energy) is applied to the ink in each of the plurality of pressure chambers 12p, and causes the ink to be ejected or discharged from the nozzle 12n. The actuator 13x is provided on each of the plurality of individual electrodes 13c (i.e., each of the nozzles 12n) and is deformable independently depending on the potential supplied to each of the plurality of individual electrodes 13c.

Next, a driving system of the actuator 13x by the controller 5 will be explained.

Note that the present embodiment satisfies a condition that “the Ohnesorge number Oh, which is represented by the following formula with “viscosity μ, density ρ and surface tension σ of an ink stored in an ink tank (namely, of the ink discharged from the nozzle 12n) and diameter D of the nozzle 12n (diameter of an opening at a forward end of the nozzle 12n), is within a range from 0.17 to 0.34”.

$$Oh = \frac{μ}{\sqrt{ρσ D}} \qquad [ Formula 1 ]$$

[μ: viscosity (mPa·s) of the ink; ρ: density (g/m³) of the ink; σ: surface tension (mN/m) of the ink; D: diameter (μm) of the nozzle 12n]

The density ρ is in a range from 0.9 g/m³ to 1.2 g/m³, the viscosity μ is in a range from 4.0 mPa·s to 10.0 mPa·s, the surface tension σ is not less than 30 mN/m, and the diameter D is in a range from 17 μm to 24 μm.

Furthermore, the Reynolds' number Re represented by the following formula is in a range from 19 to 35.

$$Re = \frac{ρ vD}{μ} \qquad [ Formula 2 ]$$

Moreover, the Weber number We represented by the following formula is in a range from 37 to 52.

$$We = \frac{ρ {Dv}^{2}}{σ} \qquad [ Formula 3 ]$$

Under the above-described condition, the controller 5 drives the actuator 13x so that the velocity v of the ink discharged from each of the plurality of nozzles 12n becomes to be not more than 8 m/s.

Specifically, the controller 5 controls the conveying motor 43 and the driver IC 14 based on a recording instruction (including an image data) received from an external apparatus, etc. The controller 5 causes the conveying motor 43 and the driver IC 14 to perform a conveying operation of conveying the paper sheet 9 and a discharging operation of discharging the ink from the nozzles 12n with respect to the paper sheet 9, thereby recording an image on the paper sheet 9. At this time, the controller 5 transmits the control signal to the driver IC 14. The driver IC 14 generates the driving signal based on the control signal, and supplies the driving signal to each of the plurality of individual electrodes 13c.

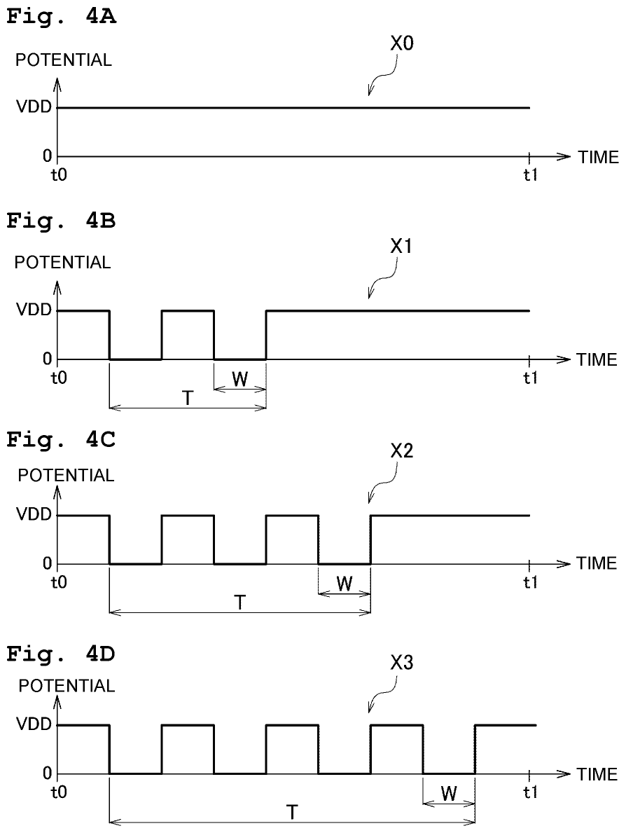

As depicted in FIGS. 4A to 4D, the driving signal includes four types of driving signals depending on the discharge amount of the ink from the nozzle 12n within one discharging cycle (a time period from a point of time t0 up to a point of time t1). Any one driving signal among the four kinds of driving signals is supplied to each of the plurality of individual electrodes 13c per each discharging cycle.

A driving signal X0 depicted in FIG. 4A relates to a discharge amount corresponding to “Zero (no discharge)” and maintains the potential of each of the plurality of individual electrodes 13c at a certain driving voltage (VDD). A driving signal X1 depicted in FIG. 4B relates to a discharge amount corresponding to “Small” and includes two pulses each of which changes the potential of each of the plurality of individual electrodes 13c between the driving voltage (VDD) and the ground potential (0V), and causes two droplets of the ink (two ink droplets) to be discharged. A driving signal X2 depicted in FIG. 4C relates to a discharge amount corresponding to “Medium” and includes three pulses each of which changes the potential of each of the plurality of individual electrodes 13c between the driving voltage VDD) and the ground potential (0V), and causes three droplets of the ink (three ink droplets) to be discharged. A driving signal X3 depicted in FIG. 4D relates to a discharge amount corresponding to “Large” and includes four pulses each of which changes the potential of each of the plurality of individual electrodes 13c between the driving voltage (VDD) and the ground potential (0V), and causes four droplets of the ink (four ink droplets) to be discharged.

In this manner, the controller 5 supplies, with respect to the actuator 13x, the driving signals X1 to X3 each of which contains the plurality of pulses per one discharging cycle.

In each of the driving signals X1 to X3, a width W of a last pulse among the plurality of pulses is shorter than Acoustic Length (one way propagation time of the pressure wave in the individual channel 12b). In the following explanation, the Acoustic Length is referred to as “AL”.

Further, in each of the driving signals X1 to X3, a time T from a rising point of time of a first pulse among the plurality of pulses to a falling point of time of the last pulse is shorter than a breaking-up time Topt represented by the following formula (see “Note on Dimensionless Parameters Used in Atomization Studies” by Takashi SUZUKI, Toyohashi Univ. of Tech., ATOMIZATION: journal of the ILASS-Japan, vol. 9, no. 25 (2000)).

$$Topt = \frac{1}{Sopt} ln ( \frac{D}{2 {δ}^{*}} ) \qquad [ Formula 4 ]$$

[δ*: minute amplitude in initial disturbance]

$$Sopt = \frac{1}{\{ 1 + 30 h \}} \sqrt{\frac{σ}{ρ {D}^{3}}} \qquad [ Formula 5 ]$$

In a case that the potential of each of the plurality of individual electrodes 13c is the driving voltage (VDD), the actuator 13x (see FIG. 3) is in a state of being deformed to project toward one of the plurality of pressure chambers 12p. Provided that this state is defined as the initial state, in a case that thereafter the potential of the individual electrode 13c changes from the driving voltage (VDD) to the ground potential (0V), the actuator 13x becomes to be flat and the volume of the pressure chamber 12p is increased to be greater than that in the initial state. At this time, the ink is sucked into the individual channel 12b from the common channel 12a. Further after that, in a case that the potential of the individual electrode 13c changes from the ground potential (0V) to the driving voltage (VDD), the actuator 13x is allowed to be again in the state of being deformed to project toward the pressure chamber 12p. At this time, due to the decrease in the volume of the pressure chamber 12p, the pressure of the ink in the pressure chamber 12p is increased, thereby discharging or ejecting one droplet of the ink (one ink droplet) from the nozzle 12n.

That is, the present embodiment adopts, as the driving system of the actuator 13x, a “pull-strike system” in which the volume of each of the plurality of pressure chambers 12p is temporarily increased, and then the volume of the pressure chamber 12p is restored to the original state after the predetermined time has elapsed since the temporary increase in the volume, thereby imparting, to the ink in the pressure chamber 12p, the energy for discharging or ejecting the ink from the nozzle 12n. In the “pull-strike system”, a negative pressure wave is generated in the pressure chamber 12p in a case that the volume of the pressure chamber 12p is increased, and then the volume of the pressure chamber 12p is returned to the original state at a timing at which the negative pressure wave is inverted to return to the pressure chamber 12p as a positive pressure wave, thereby generating a positive pressure wave in the pressure chamber 12p, and these pressure waves are superimposed. By such a superimposing of the pressure waves, it is possible to impart a large pressure to the ink in the pressure chamber 12p.

As described above, according to the present embodiment, both a condition that the Ohnesorge number Oh is in the range from 0.17 to 0.34 and a condition that the velocity v of the ink discharged from the nozzle 12n is not more than 8 m/s are satisfied. In a case that the Ohnesorge number Oh is too low (in a case that the Ohnesorge number is less than 0.17), the ink discharged from the nozzle 12n is likely to break or split and a satellite is likely to be generated. In a case that the Ohnesorge number Oh is too high (in a case that the Ohnesorge number exceeds 0.34), a mist is likely to be generated due the Rayleigh instability. Further, in a case that the velocity v is too high (in a case that the velocity v exceeds 8 m/s), the satellite and/or the mist are likely to be generated. In the present embodiment, by making each of the Ohnesorge number Oh and the velocity v to be within the predetermined range, it is possible to suppress the generation of the satellite and/or the mist, as will be indicated in Examples to be described later on. In other words, by determining the diameter D of the nozzle 12n and the velocity v in accordance with the properties of the liquid (the viscosity μ, the density ρ, the surface tension σ), it is possible to provide a printer 100 capable of forming a high-quality image, while making the satellite and/or the mist to less likely to be generated.

The density ρ is in the range from 0.9 g/m³ to 1.2 g/m³. According to this configuration, the condition indicated in Examples to be described later on is met, thereby making it possible to reliably obtain the above-mentioned effect (the effect that the satellite and/or the mist can be suppressed).

The viscosity μ is in the range from 4.0 mPa·s to 10.0 mPa·s. According to this configuration, the condition indicated in Examples to be described later on is met, thereby making it possible to reliably obtain the above-mentioned effect (the effect that the satellite and/or the mist can be suppressed).

The surface tension σ is not less than 30 mN/m. According to this configuration, the condition indicated in Examples to be described later on is met, thereby making it possible to reliably obtain the above-mentioned effect (the effect that the satellite and/or the mist can be suppressed).

The diameter D is in the range from 17 μm to 24 μm. According to this configuration, the condition indicated in Examples to be described later on is met, thereby making it possible to reliably obtain the above-mentioned effect (the effect that the satellite and/or the mist can be suppressed).

The Reynolds' number Re is in the range from 19 to 35. According to this configuration, the condition indicated in Examples to be described later on is met, thereby making it possible to reliably obtain the above-mentioned effect (the effect that the satellite and/or the mist can be suppressed).

The Weber number We is in the range of 37 to 52. According to this configuration, the condition indicated in Examples to be described later on is met, thereby making it possible to reliably obtain the above-mentioned effect (the effect that the satellite and/or the mist can be suppressed).

The controller 5 supplies, with respect to the actuator 13x, the driving signals X1 to X3 each of which contains the plurality of pulses in one discharging cycle (see FIGS. 4A to 4D). Provide that only one pulse is included in each of the driving signals X1 to X3, the pressure is applied to the ink in the pressure chamber 12p at the timing of the falling of the one pulse, and although the ink protrudes from the nozzle 12n when the ink is to be discharged from the nozzle 12n, there is a high possibility that an external force for tearing or breaking the protruding ink cannot be properly applied (which in turn consequently generates the satellite and/or the mist). In contrast, in the configuration of the present disclosure, owning to the second and subsequent pulse(s), the external force for tearing or breaking the ink can be properly applied, thereby making it possible to suppress the generation of the satellite and/or the mist more reliably.

In each of the driving signal X1 to X3, the width W of the last pulse among the plurality of pulses is shorter than AL (see FIGS. 4A to 4D). In this case, since the width W of the last pulse is shorter than AL, it is thereby possible to tear the ink protruding from the nozzle 12n and to eject or discharge the ink from the nozzle 12n before any mist is generated due to the Rayleigh instability. Therefore, it is possible to suppress the generation of the mist more reliably.

In each of the driving signal X1 to X3, the time T from the rising point of time of the first pulse among the plurality of pulses to the falling point of time of the last pulse is shorter than the breaking-up time Topt. In this case, since the time T is shorter than the breaking-up time Topt, it is possible to tear or break the ink protruding from the nozzle 12n and to eject or discharge the ink from the nozzle 12n, before the breaking of the ink. Therefore, it is possible to more reliably suppress the satellite which would be caused due to the breaking of the ink.

The driving system of the actuator 13x by the controller 5 is the “pull-strike system” in which the volume of each of the plurality of pressure chambers 12p is temporarily increased, and then the volume of the pressure chamber 12p is restored to the original state after the predetermined time has elapsed since the temporary increase in the volume, thereby imparting, to the ink in the pressure chamber 12p, the energy for discharging or ejecting the ink from the nozzle 12n. In the case of the “pull-strike system”, since the energy can be efficiently imparted to the ink in the pressure chamber 12p by using the pressure wave propagating the pressure chamber 12p, it is possible to perform the discharge or ejecting of the ink accompanying with the pulse change more quickly, as compared with a case of a “push-strike system (a system in which the actuator 13x is maintained to be flat in advance, and then the actuator 12x is deformed to project toward the pressure chamber 12p at a predetermined timing so as to decrease the volume of the pressure chamber 12p, thereby imparting, to the ink in the pressure chamber 12p, the energy of ejecting or discharging the ink from the nozzle 12n). Therefore, it is possible to tear the ink and to eject or discharge the ink from the nozzle 12n before any mist is generated due to the Rayleigh instability, thereby making it possible to suppress the generation of the mist more reliably.

### EXAMPLES

Experiments were conducted under various conditions in order to verify the effects of the present disclosure. The details and results of the experiments will be explained below, with reference to TABLE 1 indicated below.

TABLE 1

| | μ: | ρ: | σ: | D: | v: | | | | |
|---|---|---|---|---|---|---|---|---|---|
| | viscosity | density | surface | diameter | discharge- | | | | Presence or |
| | of the | of the | tension | of the | ing | Reynolds′ | Weber | Ohnesorge | Absence of |
| | ink | ink | of the ink | nozzle | velocity | number | number | number | Satellite |
| | (mPa · s) | (g/m³) | (mN/m) | (μm) | (m/s) | Rs | We | Oh | and/or Mist |
| Example 1 | 4.0 | 1.0 | 30.0 | 17.5 | 8.0 | 35.0 | 39.0 | 0.17 | Absent |
| | | | | | | | | | (G) |
| Example 2 | 7.0 | 1.0 | 31.3 | 17.5 | 8.0 | 20.0 | 37.4 | 0.29 | Absent |
| | | | | | | | | | (G) |
| Example 3 | 9.9 | 1.0 | 33.7 | 17.5 | 8.0 | 14.1 | 33.2 | 0.41 | Present |
| | | | | | | | | | (NG) |
| Example 4 | 13.8 | 1.0 | 30.0 | 17.5 | 8.0 | 10.1 | 39.0 | 0.59 | Present |
| | | | | | | | | | (NG) |
| Example 5 | 4.0 | 1.0 | 30.0 | 24.0 | 8.0 | 48.0 | 53.5 | 0.15 | Present |
| | | | | | | | | | (NG) |
| Example 6 | 7.0 | 1.0 | 31.3 | 24.0 | 8.0 | 27.4 | 51.3 | 0.25 | Absent |
| | | | | | | | | | (G) |
| Example 7 | 9.9 | 1.0 | 33.7 | 24.0 | 8.0 | 19.4 | 47.6 | 0.34 | Absent |
| | | | | | | | | | (G) |
| Example 8 | 13.8 | 1.0 | 30.0 | 24.0 | 8.0 | 13.9 | 53.5 | 0.50 | Present |
| | | | | | | | | | (NG) |

In Examples 1 to 8 of TABLE 1, the properties of the ink (viscosity μ and the surface tension σ) inside the head 1 and the diameter D of the nozzle 12n (diameter of an opening at a forward end of the nozzle 12n) of the head 1 are different from one another.

The Reynolds' number Re, the Weber number We, the Ohnesorge number Oh of each of Examples 1 to 8 were each derived from the properties of the ink (the viscosity μ, density p and the surface tension σ), the diameter D of the nozzle 12n, the discharging velocity v, etc., by the above-described formulae.

Each of Examples 1 to 8 used a general-purpose water-based ink and the density p was made uniform among Examples 1 to 8.

Further, in order to make the discharge velocity v be uniform among Examples 1 to 8, the driving voltage (VDD) (see FIGS. 4A to 4D) was adjusted.

Regarding the “presence/absence of satellite and/or mist” in TABLE 1, a variety of kinds of the driving signal were supplied to the actuator 13x; in a case that any satellite or mist was not detected (was absent) in at least one of the driving signals, an evaluation of “(G)” was given, whereas in a case that any satellite or mist was detected (was present) in all the driving signals, an evaluation of “(NG)” was given.

As the driving signal supplied to the actuator 13x, the driving signal X1 depicted in FIG. 4B was used. Further, signals in which the width of each of the pulses, the spacing distance between the pulses in the driving signal X1 were changed in various manners were supplied to the actuator 13x.

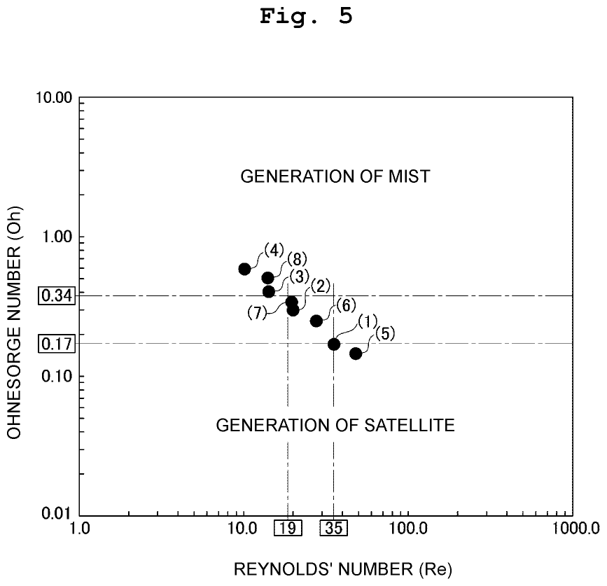

FIG. 5 indicates plotted values of the Ohnesorge number Oh and the Reynolds' number Re in Examples 1 to 8. Reference numerals (1) to (8) in FIG. 5 correspond to Examples 1 to 8, respectively.

From FIG. 5, it is appreciated that in Examples 3 to 5 and 8 in each of which the “presence/absence of satellite and/or mist” was evaluated as present “(NG)”, the Ohnesorge number Oh is outside the range from 0.17 to 0.34. In Example 5 in which the Ohnesorge number Oh was less than 0.17, the satellite was generated; and in Examples 3, 4 and 8 in each of which the Ohnesorge number Oh exceeded 0.34, the mist was generated.

Further, it is appreciated from FIG. 5 that in Examples 3 to 5 and 8 in each of which the “presence/absence of satellite and/or mist” was evaluated as present “(NG)”, the Reynolds' number Re was outside the range from 19 to 35.

In other words, in Examples 1, 2, 6 and 7 in which the “presence/absence of satellite and/or mist” was evaluated as absent “(G)”, the Ohnesorge number Oh was in the range from 0.17 to 0.34 and the Reynolds' number Re was in the range from 19 to 35.

Furthermore, from TABLE 1 as described above, in Examples 1, 2, 6 and 7 in each of which the “presence/absence of satellite and/or mist” was evaluated as absent “(G)”, the density ρ was in the range of 0.9 g/m³ to 1.2 g/m³, viscosity μ was in the range from 4.0 mPa·s to 10.0 mPa·s, the surface tension σ was not less than 30 mN/m, the diameter D was in the range from 17 μm to 24 μm, and the Weber number We was in the range from 37 to 52.

<Modifications>

Although the embodiment of the present disclosure has been explained above, the present disclosure is not limited to the above-described embodiment, and various modifications can be made within the scope of the claims.

In the above-described embodiment, the “pull-strike system” is adopted as the driving system of the actuator. The present disclosure, however, is not limited to this, and may adopt the “push-strike system”.

In the above-described embodiment, although the controller supplies, with respect to the actuator, the driving signal containing the plurality of pulses within one discharging cycle, the driving signal is not particularly limited, provided that the velocity v is not more than 8 m/s. For example, it is allowable that the controller supplies, to the actuator, a driving signal which includes one pulse within one discharging cycle.

The actuator is not limited to the piezoelectric actuator using the piezoelectric element, and may be an actuator of another system (e.g., an actuator of a thermal system using a heating element, an actuator of an electrostatic system using an electrostatic force, etc.).

The channel member in which the nozzles are formed is not limited to the channel member for the line system, and may be a channel member for the serial system (in which the liquid is ejected or discharged from the nozzles to an object of discharge while the channel member is moving in a scanning direction parallel to the paper width direction).

The object of discharge is not limited to the paper sheet and may be, for example, cloth, substrate, etc.

The liquid ejected or discharged from the nozzles is not limited to the ink, and may be any liquid (e.g., a treatment liquid which causes a component in the ink to aggregate or precipitate; etc.).

The present disclosure is not limited to the printer, and is also applicable to a facsimile machine, a copying machine, a multifunctional peripheral, etc. The present disclosure is also applicable to a liquid discharge apparatus which is used for a purpose other than the image recording (for example, a liquid discharge apparatus which forms a conductive pattern on a substrate by discharging or ejecting a conductive liquid onto the substrate).

What is claimed is:

1. A liquid discharge apparatus comprising:
a channel unit including a nozzle surface in which a nozzle is opened;
an actuator configured to apply an energy for discharging a liquid from the nozzle; and
a controller,
wherein Ohnesorge number Oh is defined by:
$$Oh = \frac{μ}{\sqrt{ρσ D}}$$
μ: viscosity (mPa·s) of the liquid; ρ: density (g/m³) of the liquid; σ: surface tension (mN/m) of the liquid; and D: diameter (μm) of the nozzle,
wherein the Ohnesorge number is in a range from 0.17 to 0.34, and
wherein the controller is configured to drive the actuator so that a velocity v of the liquid discharged from the nozzle is not more than 8 m/s.

2. The liquid discharge apparatus according to claim 1, wherein the density p is in a range from 0.9 g/m³ to 1.2 g/m³.

3. The liquid discharge apparatus according to claim 1, wherein the viscosity μ is in a range from 4.0 mPa·s to 10.0 mPa·s.

4. The liquid discharge apparatus according to claim 1, wherein the surface tension σ is not less than 30 mN/m.

5. The liquid discharge apparatus according to claim 1, wherein the diameter D is in a range from 17 μm to 24 μm.

6. The liquid discharge apparatus according to claim 1, wherein Reynolds' number Re is defined by:
$$Re = \frac{ρ vD}{μ}$$
and
wherein the Ohnesorge number is in a range from 19 to 35.

7. The liquid discharge apparatus according to claim 1, wherein Weber number We is defined by:
$$We = \frac{ρ {Dv}^{2}}{σ}$$
and
wherein the Weber number We is in a range from 37 to 52.

8. The liquid discharge apparatus according to claim 1, wherein the controller is configured to supply, to the actuator, a driving signal containing a plurality of pulses in one discharging cycle.

9. The liquid discharge apparatus according to claim 8, wherein a width of a last pulse among the plurality of pulses is shorter than Acoustic Length.

10. The liquid discharge apparatus according to claim 8, wherein a breaking-up time Topt is defined by:
$$Topt = \frac{1}{Sopt} ln ( \frac{D}{2 {δ}^{*}} )$$
[δ*: minute amplitude in initial disturbance]
$$Sopt = \frac{1}{\{ 1 + 30 h \}} \sqrt{\frac{σ}{ρ {D}^{3}}}$$
and
wherein a time from a rising point of time of a first pulse among the plurality of pulses to a falling point of time of a last pulse among the plurality of pulses is shorter than the breaking-up time Topt.

11. The liquid discharge apparatus according to claim 1, wherein the channel unit includes a pressure chamber communicating with the nozzle;
wherein the actuator covers the pressure chamber, and
wherein a driving system of the actuator by the controller is a pull-strike system in which the controller applies the energy by increasing a volume of the pressure chamber and then by restoring the volume of the pressure chamber after elapse of a predetermined time.
